(19) United States
(12) Patent Application Publication
(10) Pub. No.: US 2010/0124731 A1
(43) Pub. Date: May 20, 2010

(54) DENTAL DEVICE AND METHOD FOR LINKING PHYSICAL AND DIGITAL DATA FOR DIAGNOSTIC, TREATMENT PLANNING, PATIENT EDUCATION, COMMUNICATION, MANUFACTURING, AND DATA TRANSFER PURPOSES

(75) Inventors: Randall Clayton Groscurth, Troy, MI (US); Shoko Ueno Groscurth, Troy, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: IBUR, LLC, Troy, MI (US)

(21) Appl. No.: 12/620,851

(22) Filed: Nov. 18, 2009

Related U.S. Application Data
(60) Provisional application No. 61/115,874, filed on Nov. 18, 2008.
(60) Provisional application No. 61/270,942, filed on Jul. 15, 2009.

(51) Int. Cl. A61C 11/00; G06F 17/50

(52) U.S. Cl. 433/213; 700/119; 700/98

(57) ABSTRACT

A dental device and/or process include at least one scaled and shaped linking component to be supported by a dental model or an imaging template. The process includes scaling, aligning, and orienting data from different data acquisition sources with the scaled and shaped linking component, and combining the data from different data acquisition sources into a master data file. A method of making the diagnostic model can include virtually designing an imaging template including at least one linking component made at least partially of a radio opaque material, and three-dimensionally printing the virtually designed template. The diagnostic model can include at least one of an exposed bone structure portion, a removable gum tissue portion, a removable bone structure portion, a visualization portion illustrating a root, bone density, an internal bone structure, a nerve channel, a nerve ending, a sinus cavity, a blood vessel, an artery, and diagnostic teeth.

### RELATED INVENTIONS

This application claims priority under 35 U.S.C. §119(e) from prior U.S. Provisional Patent Application Ser. No. 61/115,874 filed Nov. 18, 2008 and Ser. No. 61/270,942 filed Jul. 15, 2009, which are both incorporated by reference herein in their entireties.

### FIELD OF THE INVENTION

The field of the invention relates to dental devices and procedures associated with various data sets from imaging and other sources of information with respect to a particular patient's physiology in physical and/or digital form and for linking data sets of information gathered regarding a particular patient's physiology into a comprehensive digital format for virtual design/illustration and manufacturing of image scanning templates, surgical guides, implants, crowns, bridges, and/or templates with optional diagnostic components useful in determining a suitable course of treatment for the particular patient.

### BACKGROUND

Physical master dental models can be of medical, dental damaged edentulous, partial edentulous, dentulous or other facial anatomical areas. Physical master dental models provide very valuable information about soft tissues and very detailed surface contours with relationship to the dental anatomy of teeth and/or tissue. This very important information of the soft tissue contours and relationship to the teeth and bones is typically not transferred accurately and mostly not transferred at all.

Making a traditional imaging template is very labor intensive with many steps. For example, a known template can be made with the following steps: Step (A): (1) 3D physical model; (2) waxing missing teeth by hand; (3) waxing tissue and other missing parts by hand; (3) duplicating wax up model with a silicone duplicating material; (4) separating the model from the silicone mold; (5) mixing a dental plaster and pouring it into the silicone mold; (6) waiting for it to harden one hour or so; (7) separating this new model from the silicone mold; (8) vacuum-forming a suck down onto this duplicated model; (9) trimming this plastic suck down (template); (10) mixing a barium powder into an acrylic mixture of powder and liquid; (11) pouring this mixture into the plastic suck down (template); (12) placing the first model together with the barium/acrylic filled template; (13) curing this in a warm water bath under vacuum; (14) separating the model from the cured acrylic (which almost always results in a broken model); (15) cleaning up the template; (16) fitting the template on to the master model (if the original master model was broken then a new master model needs to be reproduced, which can happen more then once during the process.) Step (B); any denture manufacture system can be used to create a template, which again takes a great deal of time and labor. This is only for making the imaging template. The template produced is scanned independent from and excluding any data transfer from the 3D physical model previously prepared.

A problem with computerized tomography (CT) scan images, cone beam computerized tomography (CB CT) scan images, magnetic resonance imaging (MRI) scan images, and other 3D imaging devise images is commonly referred to as “image scatter”. With CT scanning, different material in the patient's mouth can create what is called scattering of the image. This makes it difficult for the doctor to visualize teeth and bone contours, and basic anatomy, as well as any other anomalies, when analyzing the scanned image. Many times this scatter makes the imaging data unreliable, inaccurate and unusable for a proper diagnostic tool. An example of image scatter creating dental materials can include metal fillings, gold crowns and fixed partials.

One known attempt to eliminate these problems includes making a vacuum-formed plastic template from a duplicated diagnostic model. This template contains 3 mm-6 mm diameter balls of radio opaque material suitable for CT scan, CB CT scan, and/or MRI scan in several locations on the inside surface of the template. The patient wears this template in the mouth during a CT scan, CB CT scan, and/or MRI scanning process. The same template is placed back onto the 3D physical model in which it was made. The model is also subjected to a CT scan, CB CT scan, and/or MRI scanning process. Data relating to the outside surface of the template is all that is obtained from these two CT scans, CB CT scans, and/or MRI scans. The two different scanned data files are then put together with computer aided design (CAD) type software. The two scanned data file are connected by the 3 mm-6 mm diameter balls of radio opaque material suitable for CT scan, CB CT scan, and/or MRI scans in several locations on the inside surface of the template. The pictures are put together by the software. If the CT scan data, CB CT scan data, and/or MRI scan data has a lot of scatter, then this information is replaced with the scanned template outside surface data. CT scan data, CB CT scan data, and/or MRI scan data does not provide data as clean and as accurate as surface scan data.

It has been found that the vacuum-formed plastic template itself adds a layer of inaccuracy. The nature of the material allows the template to flex causing distortions when making and removing it from the working model. Placing the template into the patient's mouth can cause flexing, molding and stretching of the template shape, which can vary depending on the anatomical surfaces that it is in contact with, e.g. mouth contours, teeth, and tissue. Teeth are mobile and move small amounts in many different directions independent of each other because of the periodontal membrane. Tissue is both soft and hard in the mouth which can be distorted differently, when the same amount of pressure is applied to it. Teeth and tissue being mobile in nature, an inaccurate template can actual distort the actual position of teeth and tissue. A bad fitting template also will leave open spaces or gaps in between teeth, tissue, and/or the template. The thickness of the template itself will add another layer of inaccuracy to the data.

Other known ways of matching CT model scans can include a separate CT scan and model scan being virtually connected. Small areas of teeth and tissue from both scan data files are selected and matched together. This process is problematic if the CT image has scatter, since attempts to match areas or points from the model scan may not work.

### SUMMARY

The linking components can include one or more of the following features singularly or in any combination: (1) an anchor or receptor having an aperture to be fixedly connected to a dental master model; (2) a fastening connector component to be removably connected to the anchor or receptor for supporting at least one of an optional spacer and/or an imaging marker; (3) an optional spacer, if required to space an imaging template from the dental master model; and (4) a scaled and shaped imaging marker to reduce and/or eliminate information detail loss due to scatter using suitable radio opaque material in components, thereby allowing replacement of information lost with scan of model or patient's mouth to clean up CT scan data, CB CT scan data, and/or MRI scan data.

In a dental device for performing a dental procedure relating to replacement of teeth including a particular mouth formation of a patient and an intended dental implant location with respect to the patient, the improvement including a scaled and shaped linking component including an elongate fastening connector component and a shaped imaging/scaling marker component made at least partially of radio opaque material engageable with the elongate fastening connector component allowing at least one of a surface imaging scanning and a tomography imaging scanning of the at least one linking component creating an identifiable imaging scan data link.

In a dental device for performing a dental procedure relating to replacement of teeth including a particular mouth formation of a patient and an intended dental implant location with respect to the patient, the improvement including a linkable model, and at least one scaled and shaped linking component to be supported by the linkable model allowing surface imaging of the linkable model and linking component to create an identifiable imaging scan data link.

In a dental device for performing a dental procedure relating to replacement of teeth including a particular mouth formation of a patient and an intended dental implant location with respect to the patient, the improvement including a linkable imaging template, and at least one scaled and shaped linking component made at least partially of a radio opaque material to be supported by the linkable imaging template linkable with respect to a linkable model allowing a tomography imaging scan of physiology of the patient with the linkable imaging template and the at least one scaled and shaped linking component supported by the linkable imaging template to create an identifiable imaging scan data link.

A process for performing a dental procedure relating to replacement of teeth including a particular mouth formation of a patient and an intended dental implant location with respect to the patient, the improvement including scaling, orienting and aligning data from different data acquisition sources with respect to one another based on imaging of the at least one scaled and shaped linking component made at least partially of radio opaque material existing in the data from the different data acquisition sources, and linking the scaled, oriented, and aligned data from different data acquisition sources into a master data file.

In a dental device for performing a dental procedure relating to replacement of teeth including a particular mouth formation of a patient and an intended dental implant location with respect to the patient, the improvement including a diagnostic model formed with computer aided manufacturing using a master data file including linked, scaled, oriented, and aligned data from different data acquisition sources and including at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device for performing a dental procedure relating to replacement of teeth including a particular mouth formation of a patient and an intended dental implant location with respect to the patient made by a process including forming a diagnostic model with computer aided manufacturing using a master data file including linked, scaled, oriented, and aligned data from different data acquisition sources, and forming at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including a diagnostic model with at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including virtually designing an imaging template with at least one linking component made at least partially of a radio opaque material, and printing the virtually designed template with a three dimensional printer.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic diagram illustrating information linking mechanisms with linking components;

FIG. 2 is a perspective view of a linkable master dental model and impression having anchors and fastener connector components embedded in the master dental model and impression for linking the imaging components;

FIG. 3 is a detailed view of a linkable master dental model having apertures and linking anchors placed in the master dental model;

FIG. 4A is a perspective view of a plurality of between 3 mm-6 mm, inclusive, slotted, drilled, orientation ball and pin combinations associated with a hollow bone section diagnostic model;

FIG. 4B is a cross-sectional view of one of the between 3 mm-6 mm, inclusive, slotted, drilled, orientation ball and pin combinations associated with the hollow bone diagnostic model previously illustrated in FIG. 4A;

FIG. 5 is a side view of a set of linking components including a fastening connector component with scaling lines, an imaging/scaling marker, an optional spacer, anchor, imaging template, and dental model;

FIG. 6 is a side view of a set of linking components including a fastening connector screw, an imaging/scaling marker of radio-opaque material shaped as a sphere, an optional spacer, an anchor, an imaging template and a dental model;

FIG. 7 is a side view of a set of linking components including a fastening connector component, an imaging/scaling marker of radio-opaque material shaped as a tube in a variety of lengths, an optional spacer, an anchor, an imaging template, and a dental model;

FIGS. 8A-8C are illustrations of shaped mapping or linking pins made at least partially of radio opaque materials for use in CT scans, CB CT scans, and/or MRI scans and three-dimensional surface scanning or other scanning devices including positioning pins, orientation and/or scaling pins and radio opaque material pin tubes to be fit over the positioning pins, orientation and/or scaling pins with anchors;

FIGS. 9A-9B are a perspective views of a linkable imaging template formed on a linkable master dental model with fastening connector component and anchors;

FIG. 10A is a perspective view of a master dental model having an exposed underlying bone portion that can be covered by a removable tissue portion shown in FIG. 10B;

FIG. 10B is an exploded perspective view of a master dental model having a removable tissue portion removed to expose an internal removable bone structure portion;

FIG. 11 is a perspective view of a diagnostic model with bordered tissue and tissue veneer plus facial veneer diagnostic component;

FIG. 12A is a perspective view of a diagnostic model having an at least partially exposed bone portion and a facial veneer diagnostic component of an interior surface of teeth to be implanted;

FIGS. 12B-12C are perspective views of a diagnostic model having an at least partially exposed bone portion and a facial veneer diagnostic component of an exterior surface of teeth to be implanted;

FIG. 13A is a simplified cross sectional detail of a diagnostic model with exposed bone structure portion and visualization portions including a major nerve, an artery, a tooth nerve, a tooth blood vessel, a major nerve ending, a tooth root canal, a tooth pulp canal, a tooth root, a tooth nerve ending, bone density, and removable gum tissue; and

FIG. 13B is a simplified cross sectional side view of a diagnostic model with exposed bone structure portion, a removable gum tissue, and visualization portions including a tooth root, a tooth nerve, a tooth blood vessel, a main nerve, a main artery, a sinus cavity, a removable bone structure, and diagnostic teeth.

### DETAILED DESCRIPTION

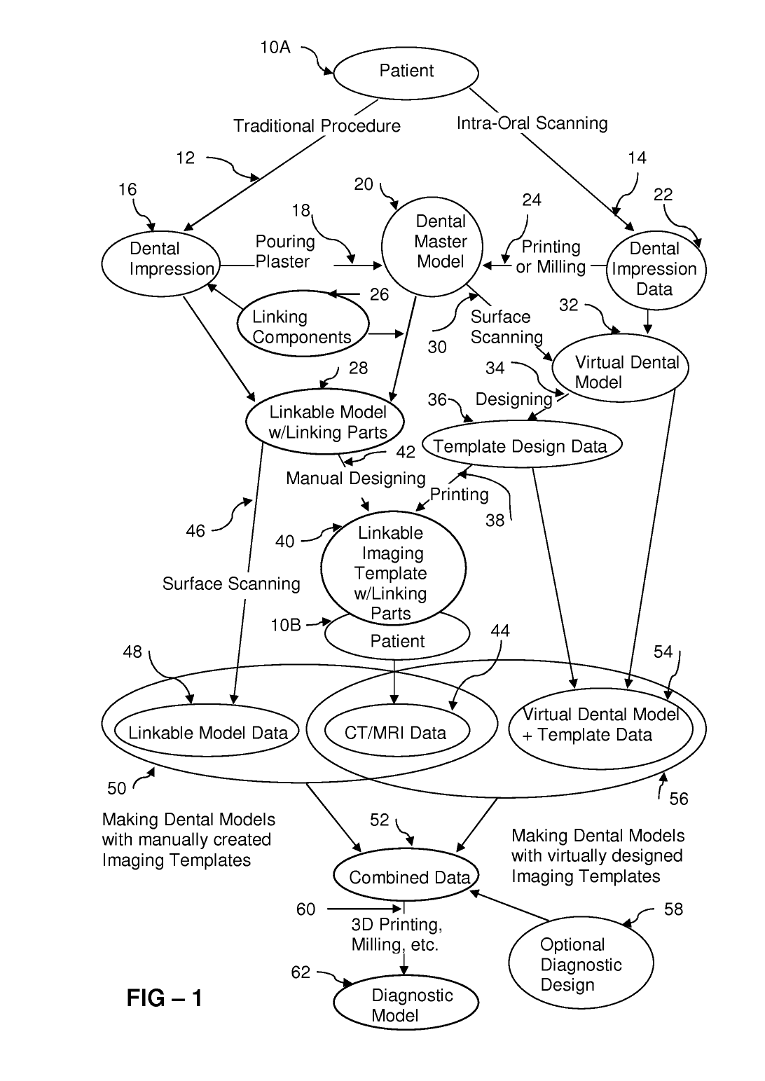

Referring now to FIG. 1, a simplified schematic diagram illustrating information linking mechanisms with linking components starts with a particular patient at a first point in time 10A undergoing either a traditional procedure 12 or an intra-oral scanning 14. The traditional procedure 12 includes a dental impression 16, pouring plaster 18 to create a dental master model 20. The intra-oral scanning 14 includes dental impression data 22, printing or milling 24 to create a dental master model 20. Linking components 26 can be associated with the dental impression 16 and the dental master model 20 to define a linkable model with linking parts 28. The linking components 26 can be used to create an identifiable imaging scan data link in common with both surface scan data files and tomography scan data files. The dental master model 20 can be surface scanned 30 to create a surface scan data file or the dental impression data can be inverted to provide a virtual dental model 32. Template design data 36 can be designed 34 with the virtual dental model 32. The template design data 36 can be used for printing 38 a linkable imaging template with linking parts 40. The linkable model with linking parts 28 can be used for manual designing 42 a linkable imaging template with linking parts 40. The linkable imaging template with linking parts 40 can be positioned in an oral cavity of the particular patient at a second point in time 10B to obtain tomography imaging scan data 44, by way of example and not limitation such as computerized tomography (CT) imaging scan data, cone beam computerized tomography (CB CT) imaging scan data, and magnetic resonance imaging (MRI) scan data, which are collectively referred to hereinafter generically as “tomography imaging scan data” 44. The linkable model with linking parts 28 including imaging/scaling markers can be surface scanned 46 to obtain a surface scan data file or linkable model data 48. The linkable model data 48 and tomography imaging scan data 44, collectively referred to as data sets 50, can be scaled, aligned, and oriented using the linking components 26 to create a combined data set 52 where dental models were made with manually created imaging templates. The virtual dental model 32 and the template design data 36 can be combined to provide virtual dental model+template data 54. The tomography imaging scan data 44 and virtual dental model+template data 54, collectively referred to as data sets 56, can be scaled, aligned, and oriented using the linkable imaging template with linking parts 40 printed 38 from the template design data 36 to create a combined data set or master data file 52 where dental models were made with virtually designed imaging templates. A master data file can be created from linked and scaled data from different data acquisition sources including at least one data acquisition source procedure selected from a tomography scan group consisting of CT image scanning the patient with a template having at least one scaled and shaped linking component, CB CT image scanning the patient with a template having at least one scaled and shaped linking component, MRI image scanning the patient with a template having at least one scaled and shaped linking component, and at least one data acquisition source procedure selected from a surface scan group consisting of intra-oral surface scanning the having at least one scaled and shaped linking component virtually placed on the data file, optical image scanning a linkable model having at least one scaled and shaped linking component, laser image scanning a linkable model having at least one scaled and shaped linking component, and surface scanning a linkable model having at least one scaled and shaped linking component. Optional diagnostic design data 58 can be incorporated into the combined data set or master data file 52. The optional diagnostic design 58 can include at least one of a fixed diagnostic component and a removable diagnostic component connected to the diagnostic model. The combined data set or master data file 52 can be used for three-dimensional (3D) printing or milling 60 of a diagnostic model 62 for performing a dental procedure relating to replacement of teeth including a particular mouth formation of a patient and an intended dental implant location with respect to the patient, where the diagnostic model 62 defines a positive likeness of at least part of an oral cavity of a particular patient for constructing a finished dental prosthesis for use in at least one procedure selected from a group consisting of diagnosis, therapeutic treatment planning, and surgery relating to a human being. The diagnostic model can be manufactured by three-dimensional printed structures made from a transparent material allowing internal three-dimensional printed structures corresponding to at least one of bone density, a root contour of a tooth, a nerve channels, a major nerve, a major nerve ending, internal bone structure, a tooth nerve, a tooth nerve ending, a tooth blood vessel, a tooth root canal, a tooth pulp canal, a blood vessel, an artery, and a sinus cavity to be made visible.

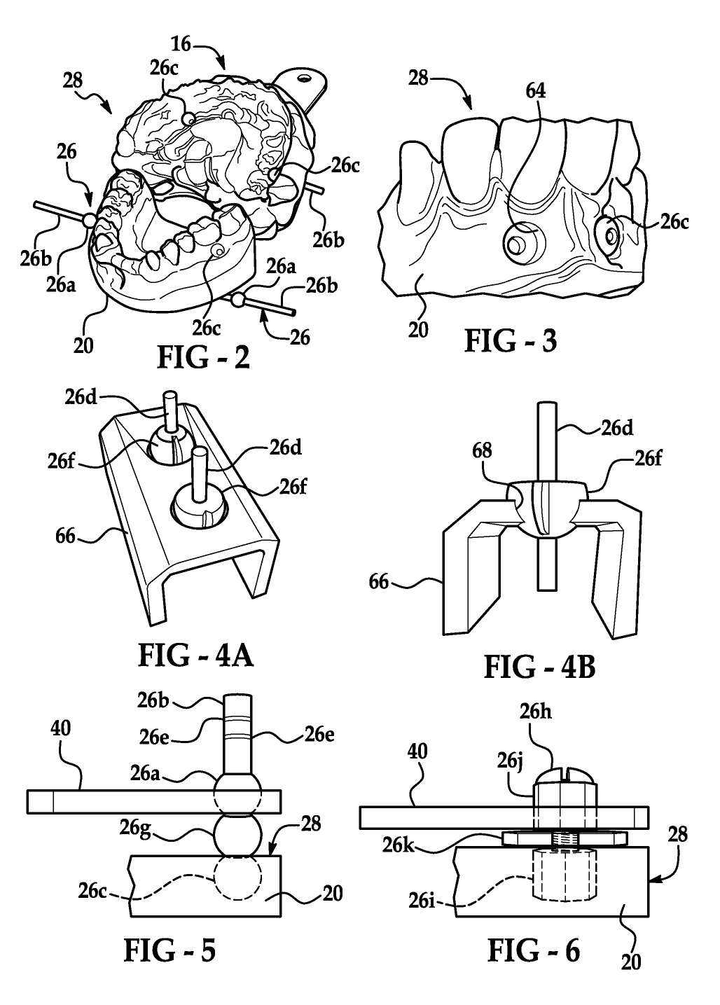

Referring now to FIG. 2, starting from a dental impression 16, a linkable model with linking parts 28, such as linking components 26, can be processed. The linking components 26 can include, by way of example and not limitation, anchors 26c and fastening connector components 26b placed within the dental impression 16 prior to pouring the model material into the impression to embed the anchors 26c within the linkable model with linking parts 28. Imaging/scaling marker 26a can be positioned on the fastening connector components 26b supported by the anchors embedded within the linkable model 28.

Alternatively, as illustrated in FIG. 3, starting from a dental master model 20, a linkable model with linking parts 28, such as linking components 26, can be processed. The dental master model 20 can be drilled subgingevally, lingually, facially or palatally in one or more locations. The diameter of the drilled apertures 64 corresponds with a diameter of desired anchors 26c. The linking components 26 can include, by way of example and not limitation, anchors 26c and fastening connector component 26b fixed within the drilled apertures 64 to embed the anchors 26c within the linkable model with linking parts 28.

Referring now to FIG. 5, a side view of a linking component including a fastening connector component 26b with scaling lines 26e is illustrated with a sphere-shaped anchor 26c embedded within a linkable model with linking parts 28. A radio-opaque imaging/scaling sphere-shaped marker 26a can be associated or fixed with respect to a linkable imaging template with linking parts 40. An optional spacer 26g can be located between an anchor 26c and an imaging/scaling sphere 26a, if desired.

Referring now to FIG. 6, a side view of a linking component including a fastening connector screw 26h is illustrated with a threaded anchor component 26i embedded within a linkable model with linking parts 28. A radio-opaque imaging/scaling marker component 26j can be associated or fixed with respect to a linkable imaging template with linking parts 40. An optional spacer 26k can be located between an anchor 26i and an imaging/scaling marker component 26j, if desired.

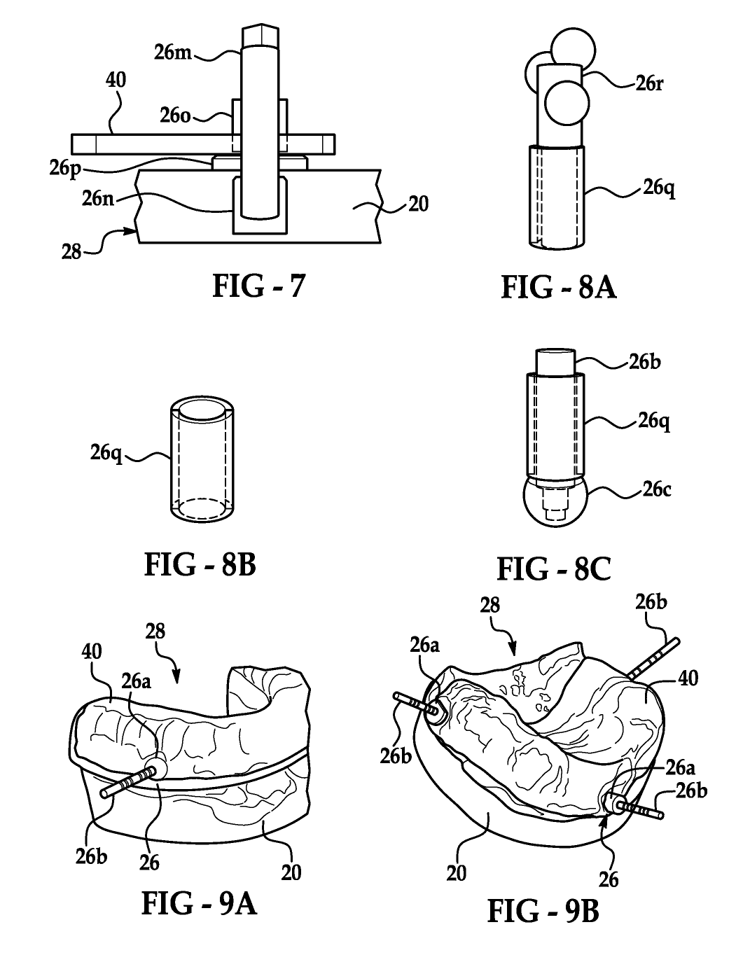

Referring now to FIG. 7, a side view of a linking component including fastener connector component 26m is illustrated with an anchor 26n embedded within a linkable model with linking parts 28. A radio-opaque imaging/scaling tube-shaped marker 26o can be made in a variety of lengths, and associated or fixed with respect to a linkable imaging template with linking parts 40. An optional spacer 26p can be located between an anchor 26n and an imaging/scaling marker 26o, if desired.

Referring now to FIGS. 8A-8C, by way of example and not limitation, an interchangeable cylindrical or tube shaped component 26q can be made of radio-opaque or non-radio-opaque material and used in combination with more complex shaped fastening connector component 26r made from radio-opaque or non-radio-opaque material for CT scanning, CB CT scanning, MRI scanning, or 3D surface scanning devices. The cylindrical component 26q can be supported by an orientation anchor 26c, or other anchor component such as those described above, and fastening connector component 26b combination with respect to a linkable model with linking parts 28. The anchor 26c and fastening connector component 26b can provide placement, angular orientation, and fixturing of the cylindrical component 26q with respect to a linkable imaging template with linking parts 40. After the cylindrical component 26q is removed from the fastening connector component 26b, a more complex shaped fastening connector component 26r can be supported within the interchangeable component 26q for 3D surface scanning devices.

Referring now to FIGS. 9A-9B, a linkable model with linking parts 28 is illustrated. All of the tissue area on the linkable model has been blocked out with a thin layer of block out material. Fastening connector component 26b can be inserted into corresponding anchors 26c. Radio-opaque imaging/scaling markers, by way of example and not limitation, such as markers 26a, 26j, 26n, 26o or 26q described in greater detail above, can be placed on the fastening connector component 26b for an imaging scan, such a 3D surface scanner to create a first imaging scan data set or surface scan data file. Tray material can be applied to the model embedding the radio-opaque linking components 26 to form a linkable imaging template with linking parts 40. The linking components 26 extend sufficiently outside of the imaging template to be exposed. Radio-opaque diagnostics can be placed on the model, and incorporated into the imaging template, if desired. The fastening connector components 26b can be removed from the cured imaging template and underlying model to allow the imaging template to be removed from the model and cleaned. Optionally, the cleaned imaging template can be repositioned on the model, and a 3D surface scan can be performed to create a surface scan data file of the imaging template, if linking components 26 are exposed sufficiently for surface matching to create a second imaging scan data set. The imaging template can then be sent to a doctor's office and positioned in the corresponding patient's mouth for another imaging scan to create a third imaging scan data set. Optionally, the imaging template alone can be subjected to an imaging scan to create a fourth imaging scan data set. The imaging scan of the patient with the imaging template in place can be selected from one or more of the following scans: a CT imaging scan of a physiology of the patient and imaging template, CB CT imaging scan of the physiology of the patient and imaging template, and MRI imaging scan of the physiology of the patient and imaging template. Scanned data can be sent or transferred between the doctor and/or technician as required using any suitable media or device or protocol. CT data files, CB CT data files, and MRI data files can be translated into a file format corresponding with 3D surface scanning data, or the data files can be converted into any compatible file format desired. After being translated into a compatible file format, the first, second, third, and optionally fourth data sets can be scaled, aligned, oriented and linked using the linking components 26 existing in each of the data sets.

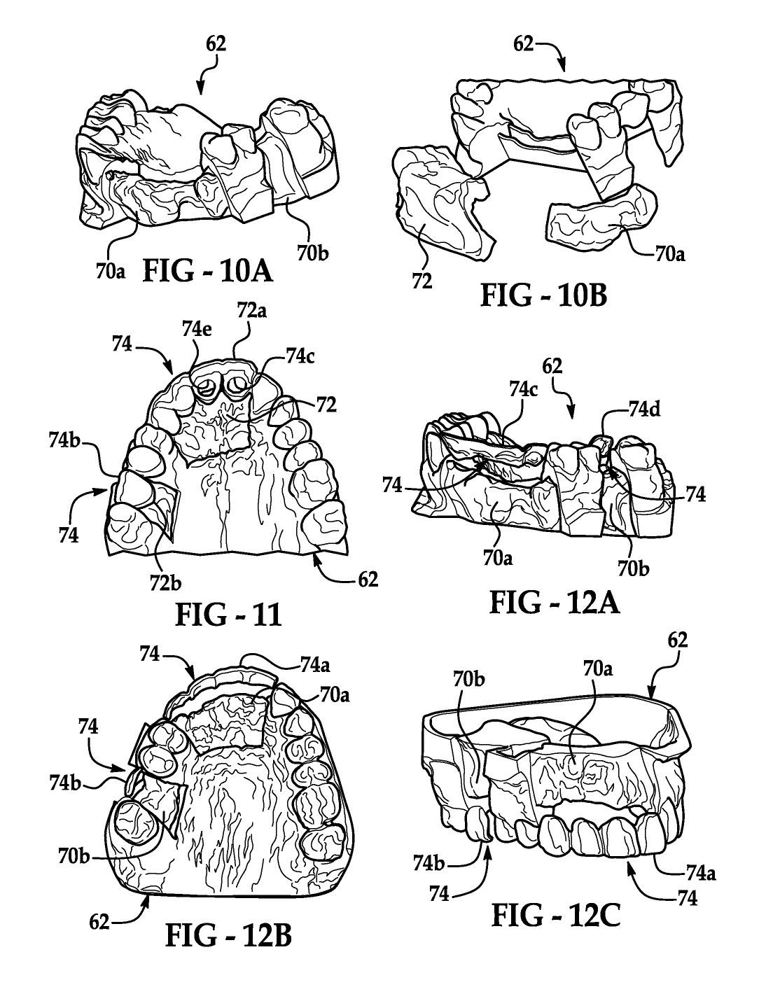

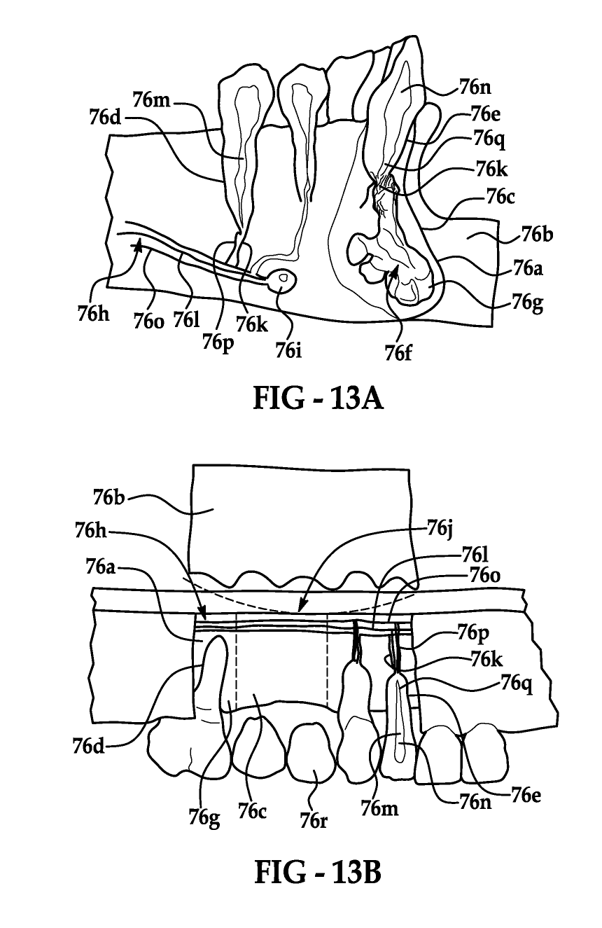

Referring now to FIG. 10A, a physical three dimensional (3D) diagnostic model 62 is illustrated with partially exposed bone structure portion 70a, 70b with or without a removable tissue portion 72, as shown in FIG. 10B. The 3D diagnostic model 62 can be made of solid color material, a transparent material, or a combination of different colors and/or a combination of different types of materials, by way of example and not limitation, such as hard materials, flexible materials, plastic materials, metal materials, ceramic materials, stone materials, or any combination thereof. Different combinations of transparent, opaque, and solid colored materials can be used when desired to make various physiology in a diagnostic model of a particular patient visible, i.e. providing a visualization portion 76 of detailed bone/tissue anatomy for the doctor or surgeon of a proposed treatment site including internal three dimensional printed structures, by way of example and not limitation, such as an exposed bone structure 76a, removable gum tissue 76b, removable bone structure 76c, a root of a tooth 76d, a root section contour of a tooth 76e, bone density 76f, internal bone structure 76g, a nerve channel 76h, a major nerve ending 76i, a sinus cavity 76j, a tooth blood vessel 76k, an artery 76l, a tooth root canal 76m, a tooth pulp canal 76n, a major nerve 76o, a tooth nerve 76p, a tooth nerve ending 76q, diagnostic teeth 76r, and any combination thereof as shown schematically in FIG. 13A-13B. The 3D diagnostic model 62 can include an XYZ measurement scale placed in at least one location for verification of accuracy of the model. Information related to the case can be printed on the 3D diagnostic model 62, by way of example and not limitation, a doctor's name, a patient's name, an identification number, a case reference number, or any combination thereof. The 3D diagnostic model 62 can be created by different methods, by way of example and not limitation, such as computer numeric controlled (CNC) milling machines, and various types of 3D printers. When 3D printers are used to create physical three dimensional printed structures of the 3D diagnostic model 62, not only surface defects of the bone, but also porosity inside the bone cavity be visible by slicing the model 62 or coloring the porous area on transparent models. Depending on the quality of the CT/CB CT/MRI scan data bone density can be color coded also. By using a 3D printer, the 3D diagnostic model 62 can be printed along with an opposing model articulated properly with a functioning printed articulator, since 3D printers can print these components together or separately. In any case, the 3D diagnostic model 62 can include various types of fixed or removable diagnostic components as described in greater detail below.

Referring now to FIG. 11, a physical 3D diagnostic model 62 is illustrated with a diagnostic component 74, by way of example and not limitation, bordered tissue/tissue veneer diagnostic 72a, 72b and facial veneer diagnostic 74a, 74b. Diagnostic components 74 can be placed within and/or onto a 3D diagnostic model 62 and can include fixed diagnostic teeth, and/or fixed diagnostic tissue, and/or removable diagnostic teeth and/or removable diagnostic tissue. Diagnostic components 74 can be made by any suitable traditional process, by way of example and not limitation, such as diagnostic wax-ups, plastic or radio-opaque plastic diagnostic teeth duplicated from wax diagnostics. If desired, the plastic can be ultraviolet (UV) or white light cured plastic. Diagnostic components 74 can be made with precious, semi-precious, or non-precious metals. Diagnostic components 74 can be virtually designed separated from or incorporated within the 3D diagnostic model 62. The virtually designed diagnostic components 74 can be manufactured in conjunction with or separately from the 3D diagnostic model 62 by CNC milling machines, or various types of 3D printers. The diagnostic components 74 can be made of waxes, plastics, or various types of metal like traditional diagnostic components. By way of example and not limitation, diagnostic components 74 can include solid teeth, either connected to or separated from each other, veneers, such as facial veneers 74a, 74b illustrated in FIGS. 11, 12B, 12C or lingual veneers 74c, 74d illustrated in FIG. 12A, bordered tissue, tissue veneers, or different combinations of various veneers, either connected to or separated from each other. Diagnostic components 74 can also include lingual tissue or bordered tissue veneer designs, which can also be attached to a facial veneer, or layered onto the tissue material separated from the facial veneer. Hollow diagnostic component 74 designs, i.e. negative of solid shapes, connect to or separated from each other, can be printed within the material that is adaptable onto or with the 3D diagnostic model 62. Diagnostic components 74 can also include implants and all implant related components, by way of example and not limitation, such as different types of implant bars, abutments, and surgical guide designs. Implant diagnostic components 74 can be solid or hollowed out. Implant diagnostic components 74 can also have apertures 74e in the middle of the implant positions so that the pins 26b can be inserted to create a simple surgical guide, or can be created with pins 26b in the middle of the implant positions. Diagnostic components 74 can also include parts for orthodontics, parts for periodontics, parts for oral surgeons, parts for education, or any combination of the diagnostic components 74 discussed above.

Referring again to FIG. 12A, a physical 3D diagnostic model 62 is illustrated with at least partially exposed bone structure portions 70a, 70b and a diagnostic component 74, by way of example and not limitation, a lingual veneer diagnostic 74c, 74d. Diagnostic components 74 can be placed within and/or onto a 3D diagnostic model 62 and can be either fixed or removable. Tissue portions are not provided with this 3D diagnostic model 62, or if provided have been removed.

Referring again to FIGS. 12B-12C, a physical 3D diagnostic model 62 is illustrated with at least partially exposed bone structure portions 70a, 70b and a diagnostic component 74, by way of example and not limitation, a facial veneer diagnostic 74a, 74b. Diagnostic components 74 can be placed within and/or onto a 3D diagnostic model 62 and can be either fixed or removable. Tissue portions are not provided with this 3D diagnostic model 62, or if provided have been removed.

Referring now to FIGS. 4A and 4B, a plurality of diagnostic parts, by way of example and not limitation, such as between 3 mm-6 mm, inclusive, slotted, drilled, diagnostic orientation ball 26f and pin 26d combinations associated with a simplified, schematically drawn, hollow bone section 66 of a diagnostic model. The pin 26d is removable from the orientation ball 26f, and can be any desired configuration, by way of example and not limitation, such as press fit, snap fit, or threaded. The hollow bone section model 66 can be drilled subgingevally, lingually, facially or palatally in one or more locations to form an aperture 68 of a suitable diameter for a diameter of desired diagnostic orientation ball 26f and pin 26d combination. The orientation ball 26f allows angular orientation of an axis of the associated pin 26d prior to fixation with respect to the hollow bone section 66 of the diagnostic model. When properly positioned within the site for dental restoration, the orientation ball 26f and pin 26d combinations allow a simple surgical guide made on the diagnostic model for implant placement.

Linking components 26 can include (1) an anchor or receptor having an aperture to be fixedly connected to a dental master model; (2) a fastening connector component to be removably connected to the anchor or receptor at one end for supporting at least one of an optional spacer and/or an imaging marker; (3) an optional spacer, if required to space an imaging template from the dental master model; and (4) a scaled and shaped imaging marker to reduce and/or eliminate information detail loss due to scatter using radio opaque material suitable for various types of tomography scanning devices such as CT, CB CT, and MRI scanners, and also suitable for 3D surface scanning devices such as laser and optical scanners, thereby allowing replacement of information lost with scan of model or patient's mouth to clean up CT scan data, CB CT scan data, and/or MRI scan data through both image linking and physical linking. Linking components 26 can link imaging templates, dental models, tomography scan data, and surface scan data by creating more accurate visual markers with physically linkable parts where necessary. Imaging markers may have different geometric shapes for scaling and sizing, and usually made of radio-opaque materials for use with tomography scanning devices, such as CT scans, CB CT scans, MRI scans, and 3D surface imaging devices, such as laser scanners, optic scanners, and/or intra-oral scanners. Optionally, the physical linking components can include a non-radio-opaque surface marker component that is interchangeable with a radio-opaque imaging/surface marker, where physical linking and surface scanning data are desired, where radio-opacity will not be needed. A surface marker component contains at least some of the same geometric shape of an imaging/surface marker. When imaging markers are radio-opaque, dual function imaging/physical linking components 26 should be placed on areas where possible image scatters from existing metal crowns, post, etc. in the patient's mouth do not become the disturbance. For this reason, the dual function imaging/physical linking components should be commonly placed below the gum line, preferably at multiple locations, where the locations should be decided on a case by case basis. Radio opaque imaging tubes 26q, as a part of linking components 26, can be placed at possible locations of implants only when the patient does not have any metal crowns in the mouth where image scatter becomes a disturbance. For cases with metal crowns, another type of linking component 26, such as shorter tubes, small spheres, or other variation of shapes can be used in the area where disturbance from image scatter does not occur.

The functions of linking components 26 include the ability, by aligning the markers, to accurately link data from different sources of imaging devices, to clean distorted portions of data from CT/MRI/CB CT or other imaging devices by replacing the distorted portions of data with accurately aligned surface scan data. This function also allows users to replace less accurate CT/MRI/CB CT data with more accurate surface scan data in the area where more accuracy is needed for creation of dental restorations. The function of the linking components includes the ability to scale, size, align, orientate (XYZ co-ordinance), and verify the data from MRI, CT, CB CT and other imaging devices, as well as the data from optical (or laser) 3D surface scanning devices, or intra-oral surface scanning devices.

A virtually designed imaging template includes a data file containing dental model data, design of an imaging template created on the dental model data, and at least one imaging/surface marker design which location is also marked on the dental model data to create a linkable data file. A printed (or milled) virtually designed imaging template contains at least one imaging/surface marker or imaging/surface marker receptor site for the placement of an image/surface marker. Virtual generated 3D data can include CAD-CAM software and the artistic renderings from this software.

The dental device and method is a diagnostic device that accurately links a physical model to CT scan, CB CT scan, MRI scan information and/or optical scan information and/or laser scan information critical for proper diagnosis. Compared to the techniques currently used, the manufacturing process of this appliance is much simpler and faster, even though the appliance is more intricate.

The dental device and method has applications for dental and/or medical uses. By way of example and not limitation, the applications can include bridging or linking the following data: (1) 3D surface scanning data to CT scan, CB CT scan and/or MRI scan data; (2) 3D surface scanning data to CAD virtually generated 3D data; (3) CT scan, CB CT scan, and/or MRI scan data to CAD virtually generated 3D data; (4) CAD virtually generated 3D data to CAD virtually generated 3D data; and (7) in any and all combination of the aforementioned. The bridging or linking of data is for the purpose of diagnosing, treatment planning, educating, communicating, and accurately transferring data, either of a physical nature or an artistic nature, in digital or physical model form, and to any combinations of these types of information or data to the doctors, patients and technicians. The digital and/or physical model form data can also be transferred to the manufacturing facilities, allowing the manufacture of additional diagnostic tools and/or components, and to assist in the manufacturing of finished or partially finished prosthetics and/or prosthesis.

The dental device and method according to one embodiment of the invention, being able to accurately link and transfer these different groups of information—physical, CT scan, CB CT scan, MRI scan, and virtual computer aided design-computer aided manufacturing (CAD-CAM), makes possible faster manufacturing processes, that can help doctors and technicians communicate with accuracy and greater artistic abilities and more intricately produced prosthesis and prosthetics in a much faster time period than presently used techniques. This will also provide the patient and doctors with the most complete and accurate diversified package of information for their decision making process.

### Constructing a Linkable Model 28

Method 1. Starting from a dental impression, inspect and sanitize the dental impression received from the dentist. Drill holes through the impression material and the tray in one or more locations subgingivally, lingually, facially, or palatally. The diameter of the holes corresponds with the diameter of the fastener connector component. Insert the fastener connector component into the holes through the tray and the impression material. Place the linking anchors inside of the tray at the end of each fastener connector component. Make sure the anchor is touching the impression material. Fastener connector component and anchors are placed in the impression. Box in the dental impression with wax strips or other boxing materials, and pour the model material into the boxed impression. Remove the fastener connector component from the impression and the model when the linkable model 28 is cured and hardened. Separate the linkable model 28 from the impression. Clean and prepare the linkable model 28 in the traditional way. An anchor is embedded inside of the model. A linkable model 28 is provided with anchors, and fastening connector components and linking imaging/scaling marker components can be placed on the anchors.

Method 2. Starting from a dental master model 20, drill holes into the dental master model 20 subgingevally, lingually, facially or palatally in one or more locations. The diameter of the holes corresponds with the diameter of the anchors. Insert and secure the anchors into the holes of the dental master model 20. An anchor is fixed inside of the dental master model 20. A linkable model 28 is created with anchors, and fastening connector components and linking imaging/scaling marker components can be place on the anchors.

### Constructing a Linkable Imaging Templates 40 by Hand

Method 3: Starting from a linkable model 28 (made by either method 1 or method 2 above) construct the imaging template 40 by hand. Insert the fastening connector components into the anchors and place the additional radio-opaque linking imaging/scaling marker components on the fastening connector components. Different styles of linking components can be used, by way of example and not limitation, such as screw, snap, and friction fit, etc. Scan the linkable model 28 with the linking components including linking imaging/scaling marker components using the 3D surface scanner (data #1). Block out all the tissue area on the linkable model 28 with thin layer of block out material because of the tissue's flexibility in the patient's mouth. Make sure that there is no block out material on the linking anchors. Apply the tray material, by way of example and not limitation, such as ultraviolet (UV) light cured plastic, or light cured plastic, or thermal plastic to the model, and form the imaging template embedding the radio-opaque imaging/scaling marker in the material. Make sure that the radio-opaque imaging/scaling markers are somewhat exposed outside of tray. Optionally, radio-opaque diagnostics may be placed on the model, and incorporated into the template, if desired. Process the tray material according to the type of material used. When the tray material is fully cured and hardened, remove the fastening connector component and then the imaging template from the model. Clean the imaging template. Try the linkable imaging template back on the master model. 3D surface scanning can be also done at this point if linking components are exposed enough for surface matching (data #2). The imaging template is sent to the doctor's office, and tried in the patient's mouth. CT/CB CT/MRI (or other imaging devices) scanning is done with the imaging template in the patient's mouth (data #3). Optionally, the imaging template alone can be scanned by CT/CB CT/MRI (or other imaging devices) for the second time (data #4) if desired (it is not necessary for linking). Scanned data is sent to the doctor and/or the technician. Translate CT/MRI data files into the file format that corresponds with the 3D surface scanning data, and data #1 through #4 are now ready to be linked into a master data file.

Constructing a Linkable Imaging Template by Virtual Designing from a Linkable Model

Method 4: Starting from a physical linkable model (made by either method 1 or method 2 above), and virtually constructing the linkable imaging template. Scan the linkable model to create a first data file (data #1). Scan the patients bite registration to create a second data file (data #2). Virtually block out all the tissue area on the virtual dental model because of the tissue's flexibility in the patient's mouth. Virtually design an imaging template that adapts to the solid structures (such as teeth or exposed bones) on the virtual dental model, incorporating the information from the bite registration scan data. Optionally, virtually design diagnostics into the imaging template, if desired at this point. Virtually design into the imaging template linking components so that anchors align with corresponding fastening connector components and corresponding imaging/scaling markers on the virtual dental model. The imaging/scaling marker components can be printed as radio-opaque solids along with the linkable imaging template or as hollowed out areas that will be filled with radio-opaque material after printing. The virtually designed imaging template with linking components defines a third data file (data #3). Send the design data (data #3) to a 3D printer, and manufacture the linkable imaging template. Clean the imaging template, and check it on the actual physical linkable model. The linkable imaging template is sent to the doctor's office, and tried in the patient's mouth. CT/CB CT/MRI (or other imaging devices) scanning is done with the linkable imaging template in the patient's mouth to create a fourth data file (data #4). Optionally, the linkable imaging template can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optional data #5) into a compatible file format that corresponds with the 3D surface scanning data files (data #1 and/or data #2), and data files #1 through #4 (and optionally #5) are now ready to be linked into a master data file. It should be noted that a physical linking component on the linkable model can be useful when the surface of the imaging template is altered later.

Constructing a Linkable Imaging Template 40 (without Linking Device on the Master Model) by Virtual Designing

Method 5: Start from an intra-oral scanning 14 data file, or dental impression data file after being inverted 22, or virtual dental model data file 32 to virtually construct the linkable imaging template 40. Any of the above data files or sets of data from intra-oral scanning 14, dental impression 22, or virtual dental model 32 can define a first data file (data #1). Scan the patients bite registration to define a second data file (data #2). Virtually block out all the tissue area on the virtual dental model 32 because of the tissue's flexibility in the patient's mouth. Virtually design an imaging template 36 that adapts to the solid structures (such as teeth or exposed bones) on the virtual dental model 32, incorporating the information from the bite registration scan data. Optionally, virtually design diagnostics into the imaging template, if desired at this point. Virtually design into the imaging template linking components so that align anchors align with fastening connector components and imaging/scaling markers on the virtual dental model 32. The imaging/scaling marker components can be printed as radio-opaque solids along with the linkable imaging template 40 or as hollowed out areas that will be filled with radio-opaque material after printing. The virtually designed imaging template with linking parts 40 defines a third data file (data #3). Send the design data (data#3) to a 3D printer, and manufacture the linkable imaging template 40. Clean the imaging template, and check it on an actual dental master model 20. The linkable imaging template 40 is sent to the doctor's office, and tried in the patient's mouth. CT/CB CT/MRI (or other imaging devices) scanning is done with the linkable imaging template 40 in the patient's mouth to create a fourth data file (data #4). Optionally, the linkable imaging template 40 can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optionally data #5) into a compatible file format that corresponds with the 3D surface scanning data files (data #1 and/or data #2), and data files #1 through #4 (and optionally #5) are now ready to be linked into a master data file.

Suitable equipment for any of the products, methods and processes described above is commercially available. By way of example and not limitation, suitable 3D prototyping printers are commercially available, such as sold under either the EDEN series or CONNEX series (for multi-material 3D prototype printing) by Objet Geometrics, Inc. having an office in Billerica, Mass. and a headquarters located in Rehovot, Israel, or such as sold under FORTUS 3D Production Systems by Stratasys, Inc. having headquarters located in Eden Prairie, Minn. By way of example and not limitation, suitable colored and translucent materials are commercially available under tradenames such as FULLCURE material or VERO material sold by Objet Geometrics, Inc. having an office located in Bellericda, Mass. and a headquarters located in Rehovot, Israel, or under the tradenames ABSi material, or ABS-M30i material, or PC-ISO material sold by Stratasys, Inc having headquarters located in Eden Prairie, Minn. By way of example and not limitation, suitable radio opaque materials are commercially available under tradenames such as VIVO TAC materials or ORTH TAC materials sold by Ivoclar Vivadent AG having an office in Amherst, N.Y. and a headquarters in Schaan, Liechtenstein. By way of example and not limitation, suitable computer numeric controlled (CNC) equipment is commercially available, such as sold under either the VR series or VF series CNC equipment by Haas Automation, Inc. located in Oxnard, Calif., or such as sold under either the MCD series or the MAG series, or the V series by Makino, Inc. located in Tokyo, Japan. By way of example and not limitation, suitable software is commercially available, such as CT/MRI 3D view & STL translation software sold under the name MIMICS by Materialise MGX located in Leuen, Belgium, or sold under the name INVIVO DENTAL by Anatomage, Inc. located in San Jose, Calif.; or sold under the name SCANIP by Delcam, PLC located in Birmingham, UK. By way of example and not limitation, suitable software is commercially available, such as modeling/designing software sold under the name GEOMAGIC STUDIO by Geomagic, Inc. located in Research Triangle Park, N.C., or sold under the name COPY CAD, POWER SHAPE, ART CAM by Delcam, PLC located in Birmingham, UK. Each of these commercially available products can be used in any combination, subject to the manufacturer's recommendations for combining materials and prototyping printer models, to manufacture the products or practice the methods and processes described in greater detail above.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. In a dental device for performing a dental procedure relating to replacement of teeth including a particular mouth formation of a patient and an intended dental implant location with respect to the patient, the improvement comprising:
a scaled and shaped linking component including an elongate fastening connector component and a shaped imaging/scaling marker component made at least partially of a radio opaque material,
wherein the marker component is engageable with the elongate fastening connector component allowing at least one of a surface imaging scanning and a tomography imaging scanning of the at least one linking component creating an identifiable imaging scan data link.

2. The improvement of claim 1, wherein
the at least one linking component includes at least one of an anchor having an aperture and a receptor site for receiving a portion of the elongate fastening connector component.

3. In a dental device for performing a dental procedure relating to replacement of teeth including a particular mouth formation of a patient and an intended dental implant location with respect to the patient, the improvement comprising:
a linkable model; and
at least one scaled and shaped linking component selectively supported by the linkable model allowing surface imaging of the linkable model and the linking component to create an identifiable imaging scan data link.

4. The dental device of claim 3 further comprising:
the at least one linking component made at least partially of a radio opaque material to allow scanning with a tomography scanning device to create the identifiable imaging scan data link; and
a linkable imaging template linkable to the linkable model, wherein the imaging template supports the at least one linking component for positioning with respect to the mouth of the patient for scanning the patient with the tomography scanning device to create a tomography scan data file including the identifiable imaging scan data link.

5. The dental device of claim 4, wherein
the tomography scan data file includes data linked from at least one data acquisition source including the linkable imaging template and the at least one linking component made at least partially of a radio opaque material.

6. The dental device of claim 3 further comprising:
a surface scan data file including data linked from at least one data acquisition source including the linkable model, the at least linking component, and the identifiable imaging scan data link.

7. The dental device of claim 3 further comprising:
a master data file created from linked and scaled data from at least one data acquisition source including at least one data acquisition source procedure selected from a tomography scan group comprising
(a) a CT image scanning of the patient with a linkable imaging template having the at least one linking component,
(b) a CB CT image scanning of the patient with the linkable imaging template having the at least one linking component, and
(c) an MRI image scanning of the patient with the linkable imaging template having the at least one linking component; and
at least one data acquisition source procedure selected from a surface scan group comprising
(i) an intra-oral surface scanning of the patient having the at least one linking component virtually placed in the data file,
(ii) an optical image scanning of the linkable model having the at least one linking component,
(iii) a laser image scanning of the linkable model having the at least one linking component, and
(iv) a surface scanning of the linkable model having the at least one linking component.

8. In a dental device for performing a dental procedure relating to replacement of teeth including a particular mouth formation of a patient and an intended dental implant location with respect to the patient, the improvement comprising:
a linkable imaging template; and
at least one scaled and shaped linking component made at least partially of a radio opaque material and supported by the linkable imaging template, wherein the imaging template is linkable to a linkable model allowing a tomography imaging scan of the patient to create an identifiable imaging scan data link.

9. The dental device of claim 8, wherein
the linkable model supports the linkable imaging template and the at least one scaled and shaped linking component for a three dimensional surface scan to create the identifiable imaging scan data link.

10. The dental device of claim 8 further comprising:
a surface scan data file including data linked from at least one data acquisition source including the linkable model, the at least one linking component, and the identifiable imaging scan data link.

11. The dental device of claim 8, wherein
a tomography scan data file including data linked from at least one data acquisition source including the linkable imaging template, the at least one scaled and shaped linking component positioned with respect to the mouth of the patient, and the identifiable imaging scan data link.

12. The dental device of claim 8 further comprising:
a master data file created from linked and scaled data from at least one data acquisition source including at least one data acquisition source procedure selected from a tomography scan group comprising
(a) a CT image scanning of the patient with the linkable imaging template having the at least one linking component,
(b) a CB CT image scanning of the patient with the linkable imaging template having the at least one linking component, and
(c) an MRI image scanning of the patient with the linkable imaging template having the at least one linking component; and
at least one data acquisition source procedure selected from a surface scan group comprising
(i) an intra-oral surface scanning of the patient having the at least one linking component virtually placed in the data file,
(ii) an optical image scanning of the linkable model having the at least one linking component,
(iii) a laser image scanning of the linkable model having the at least one linking component, and
(iv) a surface scanning of the linkable model having the at least one linking component.

13. A process for performing a dental procedure relating to replacement of teeth including a particular mouth formation of a patient and an intended dental implant location with respect to the patient, the improvement comprising:
scaling, orienting and aligning data from at least one data acquisition source based on imaging of at least one scaled and shaped linking component made at least partially of a radio opaque material existing in the data from the at least one data acquisition source; and
linking the scaled, oriented, and aligned data from the at least one data acquisition source into a master data file.

14-15. (canceled)

16. In a dental device for performing a dental procedure relating to replacement of teeth including a particular mouth formation of a patient and an intended dental implant location with respect to the patient, the improvement comprising:
a diagnostic model formed with computer aided manufacturing using a master data file including linked, scaled, oriented, and aligned data from at least one data acquisition source and including at least one visualization portion of detailed bone/tissue anatomy formed on the diagnostic model selected from a group comprising at least a subset of an exposed bone structure portion, a removable gum tissue portion, a removable bone structure portion, a root of a tooth, a root section contour of a tooth, a bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

17.-23. (canceled)

24. A dental device defining a positive likeness of part of an oral cavity of a particular patient for constructing a finished dental prosthesis for use in at least one procedure selected from a group comprising a diagnosis, a therapeutic treatment planning, and a surgery relating to a human being, the dental device comprising:
a diagnostic model with at least one visualization portion of detailed bone/tissue anatomy formed on the diagnostic model selected from a group comprising an exposed bone structure portion, a removable gum tissue portion, a removable bone structure portion, a root of a tooth, a root section contour of a tooth, a bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

25. The dental device of claim 24 further comprising:
at least one of a fixed diagnostic component and a removable diagnostic component connected to the diagnostic model.

26. The dental device of claim 24, wherein
the diagnostic model is defined by at least one three-dimensional printed structure and made from at least one of a solid color material, a transparent material, a combination of different colors, and a combination of different types of materials.

27. The dental device of claim 24, wherein
the diagnostic model defined by at least one three-dimensional printed structure is made from a transparent material allowing at least one internal three-dimensional printed structure to correspond to at least one of the bone density, the root contour of a tooth, the nerve channel, the major nerve, the major nerve ending, the internal bone structure, the tooth nerve, the tooth nerve ending, the tooth blood vessel, the tooth root canal, the tooth pulp canal, the blood vessel, the artery, and the sinus cavity to be made visible.

28.-29. (canceled)

30. A system for performing a dental procedure related to dental implants comprising:
a model having at least one marker;
a template formed of the model, the template including at least one corresponding marker that corresponds to the at least one marker of the model; and
a tomography scan of a patient's mouth including the template, wherein the at least one marker and the at least one corresponding marker are used to orient and verify data from the tomography scan.

31. The system of claim 30, wherein the model is one of a scan of the patient's mouth and an impression of the patient's mouth.

32. The system of claim 30, wherein the at least one marker is made at least partially of a radio opaque material.

33. The system of claim 30, wherein the at least one marker is one of the model and a physical component.

34. The system of claim 33, wherein a surface scan of the model having the at least one physical component is performed.

35. The system of claim 34, wherein the at least one physical component and the corresponding marker are used to orient and verify data from the surface scan and the tomography scan.

36. A dental device comprising:
a physical diagnostic model designed using data collected from a plurality of data sources, the data sources including a surface scan representing a patient's mouth and a tomography scan of the mouth;
wherein the data from the plurality of data sources is combined using a common reference point.

37. The dental device of claim 36, wherein the diagnostic model includes at least one diagnostic component to simulate the placement of an implant.

38. The dental device of claim 37, wherein the at least one diagnostic component includes teeth, veneers, tissue, and implant components.

39. The dental device of claim 36, wherein the common reference point is a marker.

40. The system of claim 39, wherein the marker is one of a model and a physical component.
